(19) United States
(12) Patent Application Publication
(10) Pub. No.: US 2025/0280827 A1
(43) Pub. Date: Sep. 11, 2025

(54) An antifungal composition comprising natamycin and at least one insecticide

(71) Applicant: Ceradis Patent B.V., Wageningen (NL)

(72) Inventors: Wilhelmus Maria VAN DER KRIEKEN, Wageningen (NL); Emilie Flavie FRADIN, Renkum (NL)

(21) Appl. No.: 18/276,543

(22) PCT Filed: Feb. 11, 2022
(86) PCT No.: PCT/NL2022/050069

§ 371 Date: Aug. 9, 2023

(30) Foreign Application Priority Data
Feb. 11, 2021 (WO) PCT/NL2021/050092

(51) Int. Cl. A01N 43/14; A01N 25/02; A01N 53/00

(52) U.S. Cl. CPC A01N 43/14; A01N 25/02; A01N 53/00

(57) ABSTRACT

The invention relates to a composition comprising natamycin and at least one insecticide that interferes with the nervous system and/or muscular system of insects and nematodes. The invention further relates to methods employing natamycin and at least one insecticide that interferes with the nervous system and/or muscular system of insects and nematodes, preferably said composition, for protecting a plant or plant part, for improving the development and/or yield of an agricultural plant, and for protecting a soil and/or a growth substrate.

### FIELD

The invention relates to compositions to control fungal diseases on plants and plant parts and to improve development and yield of plants.

### INTRODUCTION

Plants can be attacked by many different phytopathogenic fungi which cause tremendous losses in crops worldwide. Fungal growth may also result in loss of nutrients, formation of off flavors and destruction of tissue causing quality loss after processing. In many cases, fungal infections occur in the field after which the fungi develop during storage if the conditions are favorable resulting in post-harvest losses of e.g. grain, seed, flower bulbs, seed-potatoes, fruit and vegetables or moulding of processed foods such as breakfast cereals, juices or fruit cuts.

Phytopathogenic fungi in the soil, in the field (on agricultural plant parts such as seeds, bulbs and plants) and after harvesting (e.g. on cereals, vegetables and fruits) are generally controlled by fungicides, especially synthetic fungicides. However, many fungicides lose their activity over the years due to their repeated use which resulted in development of fungal resistance. This even occurred for new fungicides which had been on the market only for a short period of time, e.g. the occurrence of a single point mutation in relevant fungi that affects the performance of strobilurin fungicides. More commonly, resistance develops gradually so that the pathogen population becomes progressively less sensitive, such as the development of resistance in Zymoseptoria tritici to the azole fungicide group. Development of resistance will always result in an increasing number of treatments and the application of higher amounts and/or of more than one fungicide.

Many fungicides currently on the market will disrupt natural ecosystems by causing harmful effects, e.g. by contaminating water sources or because of undesirable effects on non-target organisms. Besides the environmental pollution, also human health problems especially with respect to worker's safety is an important issue. In addition, high residue levels of harmful fungicides on agricultural products at the moment of consumption, even exceeding the maximum residue limits, is a serious point of concern. Consumers and governmental regulators have increasing concerns resulting in stricter regulation in for example the EU, the USA, Japan and in many other countries.

It can be concluded that in spite of the availability of many commercial fungicides and their extensive use, fungi still develop on almost all crops and harvested agricultural products. In addition, it can be concluded that in agriculture there is a high need for environmental friendly alternatives to replace the harmful synthetic fungicides which are being applied today.

For many decades the polyene macrolide antifungal natamycin has been used to prevent fungal growth on food products, mainly cheeses and dry fermented sausages. Natamycin was first described in 1957 and is produced by fermentation using a Streptomyces species, e.g. Streptomyces natalensis. Nowadays this natural antimicrobial is widely used throughout the world as a food additive.

Natamycin has a long history of safe use and, more important, up to now resistant fungi have never been found in nature. Over the years quite some literature has been published describing a potential use of natamycin in many agricultural applications. However, it can be observed that this almost never resulted in commercial use of natamycin in agriculture. This may be due to the fact that the price of natamycin, which is routinely purified before use, is high for agricultural use, especially for field use.

There is a need for natural solutions for combatting fungi and reducing economic losses in agriculture, and especially for enhanced efficacies of natamycin that will allow its commercial use in agriculture.

### BRIEF DESCRIPTION OF THE INVENTION

The invention provides an antifungal composition comprising natamycin and at least one insecticide that interferes with the nervous system and/or muscular system of insects and nematodes, wherein the ratio of natamycin over the at least one insecticide is between 200:1 and 1:1 (w/w; preferably not including 1:1)). Said at least one insecticide preferably is of subgroup 2, 3, 4, 6 and/or 28, which subgroups are identified in the document “IRAC Mode of Action Classification Scheme”.

The invention further provides an antifungal composition comprising natamycin and at least one insecticide of the subgroup 2, 3, 4, 6 and/or 28 as identified in the document “IRAC Mode of Action Classification Scheme”, wherein said antifungal composition is suitable for the control of pests that are encountered in horticulture, agriculture, and forestry, and wherein the ratio of natamycin over the at least one insecticide is between 200:1 and 1:1 (w/w).

An exception may be provided by a bio-insecticide termed funnel spider peptide or “SPEAR bioinsecticide”. This peptide is thought to target the nicotinic acetylcholine receptor and was recently found to have a novel “nerve and muscular” mode-of-action. The funnel spider peptide was inserted into a novel class 32, which may also be included as an insecticide that interferes with the nervous system and/or muscular system of insects and nematodes.

Compositions comprising natamycin and at least one existing or novel insecticide that is currently not assigned to subgroup 2, 3, 4, 6 and/or 28 as identified in the document “IRAC Mode of Action Classification Scheme” (Version 9.3 of June 2019), but is assigned to these subgroups in one or more future versions of the “IRAC Mode of Action Classification Scheme” are also part of the invention.

It was found that insecticides that disturb the nervous or muscular action in insects enhance the efficacy of natamycin against pathogenic fungi. This enhancement of natamycin efficacy was not found when it was combined with insecticides having other modes of action such as growth regulation, microbial disruptor of the insect midgut, energy metabolism (respiration) or unknown or non-specific mode of action (see “IRAC Mode of Action Classification Scheme”.

Polyene fungicides such as natamycin have been reported to interact with the plasma membrane, especially with fungal membrane sterols. Although the mode of action of natamycin was reported to differ from that of other polyene fungicides, some reports also describe the interaction of natamycin with the main fungal sterol, ergosterol (the Welscher et al., 2008. J Biol Chem 283:6393-6401), thereby modulating membrane fluidity and the function of membrane-bound enzymes. Ergosterol is the most abundant sterol in fungal cell membranes, where it regulates membrane permeability and fluidity (Douglas and Konopka, 2014. Annu Rev Microbiol 68:377-393).

Without being bound by theory, the significant stimulation of activity of natamycin by the group of insecticides that interferes with the nervous system and/or muscular system of insects and nematodes is based on the mechanism that, in fungi or spores of fungi, these insecticides influence cell membranes and/or receptors, which renders them more vulnerable for natamycin. In these more vulnerable membranes natamycin can interfere more effectively with ergosterol in the cell membrane. As a result, spore and hyphae development by the fungi is more effectively inhibited by natamycin.

It is noted that a triazole such as propiconazole inhibits the synthesis of ergosterol. Hence, a triazole compound is not likely to synergize with an insecticide of subgroup 2, 3, 4, 6 and/or 28, as a triazole does not interfere directly with a component of the cell membrane.

An antifungal composition according to the invention preferably comprises 2% to 99% (w/w) of natamycin, preferably 6% to 60% (w/w) of natamycin, and 1% to 99% (w/w) of said at least one insecticide, preferably 5-50% (w/w).

The ratio of natamycin over said at least one insecticide of subgroup 2, 3, 4, 6 and/or 28 preferably is between 100:1 and 1:1 (w/w), such as 50:1 and 25:1 (w/w).

A preferred antifungal composition according to the invention comprises natamycin and at least one insecticide from fipronil, lambda-cyhalothrin, alpha cypermethrin, emamectin benzoate, acetamiprid, clothianidin, imidacloprid, thiacloprid, thiamethoxam, abamectin and chlorantraniliprole, preferably from acetamiprid, lambda-cyhalothrin, abamectin, and alpha-cypermethrin. A further preferred antifungal composition according to the invention comprises at least two insecticides from fipronil, lambda-cyhalothrin, alpha cypermethrin, emamectin benzoate, acetamiprid, clothianidin, imidacloprid, thiacloprid, thiamethoxam, abamectin and chlorantraniliprole.

An antifungal composition according to the invention may further comprise an agriculturally acceptable carrier.

An antifungal composition according to the invention preferably is an aqueous or oily composition.

In an embodiment, the natamycin in an antifungal composition according to the invention is produced by fermenting biomass by a fermentation organism.

The natamycin in an antifungal composition according to the invention is preferably fractionated, for example by milling, to an average particle size (volume-based particle size) of between 0.5 and 10 micrometer.

An antifungal composition according to the invention preferably further comprises an insoluble polyelectrolyte complex of a polyanion, such as a lignin-compound, and a polycation, such as chitosan or poly-allylamine, in relative amounts of between 1:2 and 60:1 (w/w).

The invention further provides a method for protecting an agricultural plant or plant part, comprising providing an antifungal composition according to the invention, and applying said composition to said agricultural plant or plant part. A preferred plant part is a postharvest plant part such as a fruit or a vegetable.

The invention further provides a method for protecting an agricultural plant or plant part, comprising providing natamycin and at least one insecticide of the subgroup 2, 3, 4, 6 and/or 28 as identified in the document “IRAC Mode of Action Classification Scheme”, wherein said antifungal composition is suitable for the control of pests that are encountered in horticulture, agriculture, and forestry, and wherein the ratio of natamycin over the at least one insecticide is between 200:1 and 1:1 (w/w), and applying said natamycin and at least one of the subgroup 2, 3, 4, 6 and/or 28 as identified in the document “IRAC Mode of Action Classification Scheme” to said agricultural plant or plant part.

The invention further provides a method for improving the development and/or yield of an agricultural plant, comprising providing a composition according to the invention, and contacting the plant with said composition.

The invention further provides a method for protecting a soil and/or a growth substrate, the method comprising applying to said soil and/or a growth substrate a composition according to the invention. A preferred growth substrate is a mushroom growth substrate.

In a preferred method according to the invention, the antifungal composition is used either undiluted, or diluted up to 10⁶ times in an aqueous solution or in oil. The antifungal composition may be diluted, preferably between 10 and 10⁶ times, in an aqueous solution or in oil, prior to providing the composition to a plant, plant part, soil and/or growth substrate.

It will be clear to a person skilled in the art that a composition according to the invention may comprise mixed, undiluted or mixed, diluted natamycin and the at least one insecticide that interferes with the nervous system and/or muscular system of insects and nematodes. Said natamycin and the at least one insecticide that interferes with the nervous system and/or muscular system of insects and nematodes may be diluted separately from each other prior to mixing into a composition of the invention. Hence, a diluted composition of the invention refers to the act of diluting of a composition comprising natamycin and at least one insecticide that interferes with the nervous system and/or muscular system of insects and nematodes, the act of mixing of a diluted natamycin composition with at least one insecticide that interferes with the nervous system and/or muscular system of insects and nematodes, as well as the act of mixing of a diluted at least one insecticide that interferes with the nervous system and/or muscular system of insects and nematodes with natamycin.

The invention further provides a use of an antifungal composition according to the invention for protecting a plant, plant part, soil and/or growth substrate against fungi.

### DETAILED DESCRIPTION OF THE INVENTION

### Definitions

The term “suspension concentrate”, as used herein, refers to a suspension of solid particles in a liquid intended for dilution with water prior to use.

The term “soluble liquid”, as used herein, refers to a solution in a liquid intended for dilution with water prior to use. Said liquid may be an aqueous liquid or a non-aqueous liquid, e.g. a petroleum-based solvent such as xylene or kerosin.

The term “suspo emulsion”, as used herein, refers to a suspension of solid particles in water in combination with an oil phase in the form of an emulsion intended for dilution with water prior to use.

The term “dispersion concentrate”, as used herein, refers to a dispersion of solid particles in a liquid intended for dilution with water prior to use.

The term “water dispersible granule”, as used herein, refers to a formulation in granule form which is dispersible in water forming a dispersion such as a suspension or solution.

The term “wettable powder”, as used herein, refers to a powder formulation intended to be mixed with water or another liquid prior to use.

The term “water slurriable powder,” as used herein, refers to a powder formulation that is made into a slurry in water prior to use.

The term ‘surfactant”, as used herein, refers to ionic or non-ionic surface active agents. Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

The term “increasing biological activity”, as used herein, refers to an improvement of the curative, preventive and/or persistence performance of an active ingredient.

The term “plant part”, as used herein, refers to single cells, cell clumps and plant tissues, including tissue cultures. An example of a plant part includes, but is not limited to, pollen, ovule, leave, embryo, root, root tip, anther, flower, fruit, shoot, scion, rootstock, vegetable, protoplast, callus, and the like, preferably a fruit or vegetable.

The term “agricultural”, as used herein, refers to the practice of cultivating plants, including the cultivation of crops, ornamental plants and trees. The term “agricultural” thus includes reference to horticulture and forestry.

### Antifungal Composition

The invention provides an antifungal composition comprising natamycin and at least one insecticide that interferes with the nervous system and/or muscular system of insects and nematodes. Said at least one insecticide preferably is of subgroup 2 (GABA-gated chloride channel blocker), 3 (sodium channel modulator), 4 (competitive modulator of a nicotinic acetylcholine receptor), 6 (allosteric modulator of an glutamate-gated chloride channel) and/or 28 (Ryanodine receptor modulators), which subgroups are identified in the document “IRAC Mode of Action Classification Scheme”. The latest version of this document is of June 2019; version 9.3. It was found that a combination of one or more of said insecticides and natamycin surprisingly increases the biological activity of said natamycin, i.e. the fungicidal activity of natamycin.

A preferred insecticide is a GABA-gated chloride channel blocker. A GABA-gated chloride channel blocker is thought to act on the nervous system of insects. A preferred GABA-gated chloride channel blocker is a cyclodiene, organochlorine and/or a phenylpyrazole. A preferred GABA-gated chloride channel blocker is fipronil ((±)-5-amino-1-(2,6-dichloro-α,α,α-trifluoro-p-tolyl)-4-trifluoromethyl sulfinylpyrazole-3-carbonitrile).

A preferred insecticide is a sodium channel modulator. A sodium channel modulator is thought to act on the nervous system of insects. A preferred sodium channel modulator is a pyrethroid and/or a pyrethrin. A preferred sodium channel modulator is a cyhalothrin ([cyano-(3-phenoxyphenyl)methyl] 3-[(Z)-2-chloro-3,3,3-trifluoroprop-1-enyl]-2,2-dimethylcyclopropane-1-carboxylate), preferably lambda-cyhalothrin ([(R)-cyano-(3-phenoxyphenyl)methyl] (1S,3S)-3-[(Z)-2-chloro-3,3,3-trifluoroprop-1-enyl]-2,2-dimethylcyclopropane-1-carboxylate), and alpha cypermethrin ([(S)-cyano-(3-phenoxyphenyl)methyl] (1R,3R)-3-(2,2-dichloroethenyl)-2,2-dimethylcyclopropane-1-carboxylate).

A preferred insecticide is a competitive modulator of a nicotinic acetylcholine receptor. A nicotinic acetylcholine receptor competitive modulator is thought to act on the nervous system of insects. A preferred nicotinic acetylcholine receptor competitive modulator is a neonicotinoid. A preferred nicotinic acetylcholine receptor competitive modulator is acetamiprid (N-[(6-chloropyridin-3-yl)methyl]-N′-cyano-N-methylethanimidamide), imidacloprid (N-[1-[(6-chloropyridin-3-yl)methyl]-4,5-dihydroimidazol-2-yl]nitramide), thiacloprid ([3-[(6-chloropyridin-3-yl)methyl]-1,3-thiazolidin-2-ylidene]cyanamide), and/or thiamethoxam (N-[3-[(2-chloro-1,3-thiazol-5-yl)methyl]-5-methyl-1,3,5-oxadiazinan-4-ylidene]nitramide).

A preferred insecticide is an allosteric modulator of an glutamate-gated chloride channel. An allosteric modulator of an glutamate-gated chloride channel is thought to act on the nervous system of insects. A preferred allosteric modulator of an glutamate-gated chloride channel is an avermectin and/or milbemycin. A preferred allosteric modulator of an glutamate-gated chloride channel is abamectin ((1′R,2R,3S,4'S,6S,8′R, 10′E, 12'S, 13'S, 14′E, 16′E,20′R,21′R,24'S)-2-butan-2-yl-21′,24′-dihydroxy-12′-[(2R,4S,5S,6S)-5-[(2S,4S,5S,6S)-5-hydroxy-4-methoxy-6-methyloxan-2-yl]oxy-4-methoxy-6-methyloxan-2-yl]oxy-3,11′,13′,22′-tetramethylspiro[2,3-dihydropyran-6,6′-3,7,19-trioxatetracyclo[15.6.1.14,8.020,24]pentacosa-10, 14, 16,22-tetraene]-2′-one; (1′R,2R,3S,4′S,6S,8′R, 10′E,12′S,13′S, 14′E, 16′E,20′R,21′R,24′S)-21′,24′-dihydroxy-12′-[(2R,4S,5S,6S)-5-[(2S,4S,5S,6S)-5-hydroxy-4-methoxy-6-methyloxan-2-yl]oxy-4-methoxy-6-methyloxan-2-yl]oxy-3,11′,13′,22′-tetramethyl-2-propan-2-ylspiro[2,3-dihydropyran-6,6′-3,7,19-trioxatetracyclo[15.6.1.14,8.020,24]pentacosa-10, 14, 16,22-tetraene]-2′-one), emamectin benzoate ([(2S,3S,4S,6S)-6-[(2S,3S,4S,6R)-6-[(1′R,2R,3S,4'S,6S,8′R, 10′E, 12'S, 13'S, 14′E, 16′E,20′R, 21′R,24'S)-2-[(2S)-butan-2-yl]-21′,24′-dihydroxy-3,11′,13′,22′-tetramethyl-2′-oxospiro[2,3-dihydropyran-6,6′-3,7,19-trioxatetracyclo[15.6.1.14,8.020,24]pentacosa-10, 14, 16,22-tetraene]-12′-yl]oxy-4-methoxy-2-methyloxan-3-yl]oxy-4-methoxy-2-methyloxan-3-yl]-methylazanium; benzoate), lepimectin ([(1R,4S,5'S,6R,6′R,8R,10E,12R,13S,14E, 16E,20R,21R,24S)-6′-ethyl-21,24-dihydroxy-5′,11,13,22-tetramethyl-2-oxospiro[3,7,19-trioxatetracyclo[15.6.1.14,8.020,24]pentacosa-10, 14, 16,22-tetraene-6,2′-oxane]-12-yl] (2Z)-2-methoxyimino-2-phenylacetate), and/or milbemectin ((1R,4S,5'S,6R,6′R,8R,10E,13R,14E,16E,20R,21R,24S)-21,24-dihydroxy-5′,6′,11,13,22-pentamethylspiro[3,7,19-trioxatetracyclo[15.6.1.14,8.020,24]pentacosa-10, 14, 16,22-tetraene-6,2′-oxane]-2-one).

A preferred insecticide is a ryanodine receptor modulator. A ryanodine receptor modulatorn is thought to act on the nervous system of insects. A preferred ryanodine receptor modulator is a diamide. A preferred diamide is chlorantraniliprole (5-bromo-N-[4-chloro-2-methyl-6-(methylcarbamoyl)phenyl]-2-(3-chloropyridin-2-yl) pyrazole-3-carboxamide).

A composition of the invention preferably comprises 2% to 99% (w/w) of natamycin, preferably 5% to 60% (w/w) of natamycin, more preferably 10% to 50% (w/w) of natamycin, more preferably 20% to 40% (w/w) of natamycin, more preferably 25% to 30% (w/w) of natamycin. A composition of the invention preferably comprises 1% to 99% (w/w) of said at least one insecticide, preferably 5- to 50% (w/w), more preferably 10% to 40% (w/w) of said at least one insecticide, more preferably 20% to 30% (w/w) of said at least one insecticide, such as about 25% of said at least one insecticide. A undiluted composition of the invention preferably comprises 2% to 99% (w/w) of natamycin, preferably 6% to 60% (w/w) of natamycin, and 1% to 90% (w/w) of said at least one insecticide, preferably 5 to 50% (w/w) of said at least one insecticide.

The synergistic effects of an insecticide of subgroup 2, 3, 4, 6 and/or 28 (see IRAC Mode of Action Classification Scheme) on the fungicidal activity of natamycin is seen over a broad range of insecticide concentrations. A reason for this may be that said insecticides influence proteins in cell membranes of fungi which render these membranes more vulnerable for natamycin. As a result, spore and hyphae development are more effectively inhibited by natamycin.

It is preferred that the composition is characterized by the ratio of natamycine:insecticide (w/w). A preferred ratio between natamycin and an insecticide of subgroup 2, 3, 4, 6 and/or 28, preferably between natamycin and at least one insecticide selected from fipronil, lambda-cyhalothrin, alpha cypermethrin, emamectin benzoate, acetamiprid, clothianidin, imidacloprid, thiacloprid, thiamethoxam, abamectin and chlorantraniliprole, preferably acetamiprid, lambda-cyhalothrin, abamectin, and alpha-cypermethrin, therefore is between (natamycin:insecticide) 200:1 (w/w) and 1:1 (w/w), such as between 100:1 and 1:1, between 50:1 and 1:1, such as 25:1 and 10:1. A preferred ratio includes 10:1, 9:1, 8:1, 7:1, 6:1, 5:1, 4:1, 3:1, and 2:1.

It will be understood by a person skilled in the art that said ratio preferably is between (natamycin:insecticide) 200:1 and 1:1 (w/w) for applications as described herein.

The ratio of natamycin over a subgroup 3 and 4 insecticide such as lambda-cyhalothrin, alpha-cypermethrin, thiamethoxam, and imidacloprid preferably is between 100:1 and 1:1 (w/w). The ratio of natamycin over a subgroup 2, 6, and 28 insecticide such as acetamiprid and abamectin preferably is between 25:1 and 1:1 (w/w).

A composition of the invention preferably is fractionated, preferably by milling, for example using a bead mill such as Dynomill®. The volume-based average particle size of natamycin preferably is between 0.2 and 10 micrometer, preferably between 0.5 and 5 micrometer, more preferably between 0.5 and 2 micrometer. Methods for determining a volume-based average particle size of a composition according to the invention are known to the skilled person. For example, Hukkanen and Braatz, 2003. Sensors and Actuators B 96:451-459, discuss varies methods that can be used for determining the average particle size of a composition, including forward light scattering and ultrasonic extinction. A preferred method is based on laser diffraction analysis, for example using a Analysette 22-MicroTec plus laser-particle-sizer (Fritsch, Idar-Oberstein, Germany).

An antifungal composition according to the invention may include cellular matter. Said natamycin in a composition according to the invention is preferably produced by fermenting biomass by a fermentation organism and the cellular matter that is present in the composition is from said natamycin-producing fermentation organism. Said natamycin-producing fermentation organism includes, for example, Streptomyces natalensis and Streptomyces gilvosporeus.

Said cellular matter preferably includes compounds that are remnants of natamycin-producing bacteria, or compounds excreted by the natamycin-producing bacteria. Examples of such compounds are compounds of the bacterial cell envelope, which includes the plasma membrane and the cell wall of a natamycin-producing bacterium. Such compounds include lipids such as phospholipids and glycolipids which, upon hydrolysis such as by addition of sodium hydroxide, result in fatty acids, such as C16-C18 fatty acids.

Methods for producing natamycin by fermenting biomass by a fermentation organism such as Streptomyces natalensis and Streptomyces gilvosporeus are known in the art. Methods to purify the produced natamycin away from the bulk of the biomass are known in the art. For example, disintegration of the biomass may result in lysis and destruction of all cells of the production organism. The resulting broth comprising natamycin may be filtered to obtain a filtration cake, which subsequently is treated with an alcohol, preferably methanol and/or ethanol, to disintegrate the biomass and to dissolve at least a portion of the natamycin. If necessary, the pH may be increased to solubilize the natamycin. Subsequent neutralization will result in precipitation at least a portion of natamycin.

A composition of the invention preferably is an aqueous or non-aqueous, preferably oily, concentrated stock composition which may be diluted with a suitable diluent such as e.g. water or oil before use; or an aqueous or non-aqueous ready-to-use composition.

A composition of the invention may be used for soil treatment, to prepare a coating emulsion (e.g. for fruit or plants in the field), a wax that is applied on fruit (e.g. pineapples, oranges or apples), an oil that is applied by spraying plants in the field (e.g. bananas). A composition of the invention also includes a concentrated dry composition such as e.g. a granulate, a powder and/or a tablet which can be used to prepare compositions for immersions, spraying or dipping agricultural products.

An antifungal composition of the invention preferably is a suspension concentrate (SC), a water dispersible granule (WG), a wettable powder (WP), a suspo emulsion (oily) (SE), oil dispersion (OD), a dispersion concentrate (DC), a dry powder treatment composition, a water slurriable powder (WS), a flowable treatment composition, a water dispersible granule treatment composition, a suspo emulsion (SE) or a soluble liquid (SL).

An antifungal composition of the invention preferably comprises a polyelectrolyte complex of a polyanion and a polycation as described in the published international patent application WO2013/133706, which is incorporated herein by reference, or any other encapsulation technology known in the art, e.g. liposomes, lipid structures or empty cells of e.g. yeast in which the composition of the invention is encapsulated.

Said polyelectrolyte complex is a complex of oppositely charged polyelectrolytes (a polyanion and a polycation) which form strong electrostatic links. Said polyelectrolyte complex is an insoluble complex. This complex alone does not have antimicrobial efficacy. The polyelectrolyte complex has sticky properties and contains polar parts (charged) and apolar parts. The aromatic moieties in the complex may have affinity for antimicrobial compounds such as, for example, natamycin. In combination with the sticky character of the polyelectrolyte complex, the antimicrobial compound will be optimally deposited and adhered to the soil for use in agriculture, horticulture and mushroom cultivation.

The polyelectrolyte complex comprises a polyanion, such as a lignin-compound, for example lignosulfonate, humic acid, chondroitin sulphate and poly(acrylic acid), and a polycation, such as chitosan, oligo-chitosan, epsilon poly(L) lysine, and poly-allylamine, in a relative amount of between 1:2 and 60:1 (w/w), more preferred between 1:1 and 50:1, more preferred between 2:1 and 30:1, such as about 2:1, about 5:1, about 10:1; about 15:1, about 20:1, about 25:1 and about 30:1 (w/w). The relative amounts of a polyanion, preferably a lignin compound, and a polycation, preferably a chitosan, in a polyelectrolyte complex is most preferred about 5:1 (w/w).

The polyelectrolyte complex is preferably present in a composition of the invention in a concentration between 5-800 g/l, more preferably 50-500 and most preferably 75-250 g/l of a composition of the invention.

An antifungal composition according to the invention may further comprise one or more agriculturally acceptable carriers. Said agriculturally acceptable carrier preferably is or includes a stabilizer, a wetting agent, a dispersant, an antifreezing agent, an antifoaming agent and/or a thickening agent. The addition of small amounts of one or more agriculturally acceptable carriers may affect, preferably improve, parameters such as stability and/or efficacy of a composition according to the invention. The addition of small amounts of one or more agriculturally acceptable carriers preferably increases stability, efficacy and/or rainfastness of a composition according to the invention.

A stabilizer, when present, is preferably selected from carboxylic acids such as citric acid, acetic acid, and/or dodecylbenzensulfonic acid, orthophosphoric acid dodecylbenzensulfonic acid and suitable salts thereof. A composition of the invention may also comprise two or more different stabilizers. A stabilizer is preferably present in an amount of between 0 to up to 10% (w/v), more preferred between 0.01 to up to 5% (w/v), more preferred between 0.02 to up to 1% (w/v), more preferred about 0.05% (w/v).

A wetting agent, when present, is preferably selected from di-octylsuccinate, polyoxyethylene/polypropylene and tri-stearyl sulphonate/phosphate. A composition of the invention may also comprise two or more different wetting agents. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

A dispersant, when present, is preferably selected from Morwet® D425, lignin sulphonate, an alkylpolysaccharide, an styrene acrylic polymer, an acrylic co-polymer, and ethoxylated tristyrenephenol phosphate, for example polyethoxylated fosforic acid. A composition of the invention may also comprise two or more different dispersants. A dispersant is preferably present in an amount of between 0 to up to 10% (w/v), more preferred between 0.01 to up to 5% (w/v), more preferred between 0.02 to up to 1% (w/v), more preferred about 0.05% (w/v).

An antifreezing agent, when present, is preferably selected from glycerine, ethylene glycol, hexyleneglycol and propylene glycol. A composition of the invention may also comprise two or more different antifreezing agents. An antifreezing agent is preferably present in an amount of between 0 to up to 10% (w/v), more preferred between 0.01 to up to 5% (w/v), more preferred between 0.02 to up to 1% (w/v), more preferred about 0.05% (w/v).

An anti-foam forming agent, when present, is preferably selected from polymethylsiloxane, polydimethylsiloxane, simethicone octanol, and silicone oils. A composition of the invention may also comprise two or more different anti-foam forming agents. An anti-foam forming agent is preferably present in an amount of between 0 to up to 10% (w/v), more preferred between 0.05 to up to 5% (w/v), more preferred between 0.1 to up to 1% (w/v), more preferred about 0.05% (w/v).

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

A composition according to the invention provides a stable aqueous suspension comprising a high concentration of natamycin and said at least one insecticide, up to about 30% (w/v), with improved fungicidal activity compared to commercially available formulations of said natamycin, in the presence of relatively low amounts of adjuvants as agriculturally acceptable carriers.

In some embodiments, the composition further includes one or more physical stabilizers and/or additives such as buffers, acidifiers, and drift retardants, pigments, safeners, and preservatives.

### Methods of Use

The invention further provides a method for protecting an agricultural plant or agricultural plant part comprising providing natamycin and at least one insecticide that interferes with the nervous system and/or muscular system of insects and nematodes, and applying said natamycin and at least one insecticide to an agricultural plant or plant part such that the agricultural plant or agricultural plant part is contacted with a sufficient amount of said natamycin and at least one insecticide, whereby said natamycin and the at least one insecticide are provided in a ratio of between 200:1 and 1:1 (w/w), such as 100:1, 50:1 and 25:1.

A preferred method for protecting an agricultural plant or agricultural plant part comprises providing a composition according to the invention, and applying said composition to an agricultural plant or plant part such that the agricultural plant or agricultural plant part is contacted with a sufficient amount of said composition, whereby said composition comprises natamycin and the at least one insecticide in a ratio of between 200:1 and 1:1 (w/w), such as 100:1, 50:1 and 25:1.

Said method preferably is for protecting the plant or plant part from a fungus, preferably from a mould.

The terms “plant” and “crop”, as are used herein, both refer to a cultivated plant, tree or fungus that is cultivated for food, clothing, livestock fodder, biofuel, medicine, or other use.

Said plant part preferably is a leaf, stem, bulb, flower bulb, seed-potato, root, tuber, fruit and/or vegetable, most preferably a fruit or vegetable.

The invention further provides a method for improving the development and/or yield of an agricultural plant, comprising providing natamycin and at least one insecticide that interferes with the nervous system and/or muscular system of insects and nematodes, and contacting the plant with said natamycin and at least one insecticide that interferes with the nervous system and/or muscular system of insects and nematodes, whereby said natamycin and the at least one insecticide are provided in a ratio of between 200:1 and 1:1 (w/w), such as 100:1, 50:1 and 25:1.

A preferred method for improving the development and/or yield of an agricultural plant, comprising providing a composition according to the invention, and contacting the plant with said composition.

A composition comprising natamycin and a composition comprising at least one insecticide that interferes with the nervous system and/or muscular system of insects and nematodes, preferably a composition of the invention, can be applied in many different ways. For example, said composition or compositions can be applied by: (1) spraying plants in the field or in greenhouses optionally using a carrier such as a wax or an oil; (2) dipping bulbs or seed-potatoes; (3) adding to a plant part or root system e.g. via the soil; (4) adding to the soil or growth substrate in plants or mushrooms are developing; (5) adding to water or watering systems applied in e.g. greenhouses or in the field; (6) treating harvested plant parts such as bulbs, cereals, soybeans, flowers, fruit, vegetables or plants by e.g. dipping or spraying.

A composition of the invention can be applied without diluting or after dilution. Usually the composition of the invention will be applied via an aqueous or oil dilution, via a dressing, coating or a wax. A composition according to the invention is preferably undiluted or diluted. A composition according to the invention is preferably diluted between 10 and 10⁶ times, preferably between 10 and 1000 times, in an aqueous solution or in oil, for applications in the methods of the invention. It is easy to understand that the required amount of the composition of the invention will differ per application as different applications may require different treatments. In general, however, the amount of composition in a ready-to-use composition such as e.g. a dipping or spraying suspension, calculated back to the amount of natamycin in the composition, required to treat the product (e.g. a growth substrate, a soil, a bulb, a plant in the field or a harvested fruit) will be 10-100,000 ppm of natamycin, more preferably 50-5000 ppm of natamycin and most preferably 200-1000 ppm of natamycin.

The final amount of natamycin in a soil or growth medium, on a plant or on a harvested plant part can be expressed in different ways. As an example, a composition of the invention for immersion or spraying of products such as flower bulbs, seed-potatoes, onions, apples, pears, bananas and pineapples will generally comprise 0.01 g/l to 100 g/l, preferably 0.03 g/l to 50 g/l and most preferably 0.05 g/l to 5 g/l of natamycin. After treatment of products such as flower bulbs, seed-potatoes, onions, apples, pears, bananas and pineapples, typically the amount of natamycin on the product is 0.01-20.0 mg/dm²; preferably 0.1-10.0 mg/dm².

In case of treatment of growth substrate such as mushroom growth substrate, each spray treatment will add 0.01-5.0 grams of natamycin per m² of growth substrate, more preferably 0.02-1.0 grams of natamycin per m² of growth substrate.

In case of treatment of a soil in which e.g. vegetables or ornamental plants are grown 0.01-5.0 grams of natamycin is applied per m² which is preferably mixed in the top layer of the soil, more preferably 0.1-1.0 grams of natamycin per m². In case of a spray application on a crop in the field a typical dosage is 1-5000 grams of natamycin per hectare, more preferably 50-2000 grams per hectare. However, for a crop such as bananas, the preferred dosage of natamycin is 5-500 grams per hectare, more preferably 10-100 grams per hectare.

Natamycin and at least one insecticide that interferes with the nervous system and/or muscular system of insects and nematodes, preferably a composition of the invention, can be added at any suitable time using any suitable method to the growth medium, soil, plant or plant part; e.g. before, during or after planting of e.g. bulb, seed-potato, a cutting or a young plant; during growth in the field, after harvesting or during storage of a fruit, vegetable, nut or flower bulb.

An aspect of the invention provides a use of at least one insecticide that interferes with the nervous system and/or muscular system of insects and nematodes, for increasing biological activity of natamycin. Said use according to the invention may result in a reduced rate of application of said natamycin and/or an increase of the biological activity of said natamycin.

An aspect of the invention provides the application of at least one insecticide that interferes with the nervous system and/or muscular system of insects and nematodes, for increasing biological activity of natamycin that is present in or on a plant, plant part, or soil. Said insecticide may increase the biological activity of said natamycin. Said at least one insecticide preferably is of subgroup 2 (GABA-gated chloride channel blocker), 3 (sodium channel modulator), 4 (competitive modulator of a nicotinic acetylcholine receptor), 6 (allosteric modulator of an glutamate-gated chloride channel) and/or 28 (Ryanodine receptor modulators), as identified in the document “IRAC Mode of Action Classification Scheme”.

The terms “reduced rate of application” and “increasing biological activity” may refer to a rate of application that is more than 5%, preferably more than 10%, preferably more than 30%, reduced, when compared to the rate of application of natamycin without the at least one insecticide.

Said reduced rate of application may refer to an application rate of 1 g active ingredient (a.i.)/ha to 2.5 kg a.i./ha, preferably 20 g a.i./ha to 2 kg a.i./ha., such as a rate of 100-750 g a.i./ha., including a rate of 600 g a.i./ha., a rate of 500 g a.i./ha., a rate of 400 g a.i./ha., a rate of 300 g a.i./ha., a rate of 200 g a.i./ha., and a rate of 100 g a.i./ha.

An antifungal composition according to the invention is suitable for the control of pests that are encountered in horticulture, agriculture, and forestry. The antifungal composition is active against normally sensitive and resistant pest species and during all or individual stages of development. Prior to use, a composition comprising an antifungal composition according to the invention is preferably dissolved or dispersed in water, or diluted with water, to provide an aqueous composition comprising between 0.001 and 10 w/v % of the bioactive natamycine. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the natamycin, prior to contacting a plant, plant part or soil with the composition.

To control agricultural pests, the invention provides a use of natamycin and an insecticide that interferes with the nervous system and/or muscular system of insects and nematodes, preferably of a composition comprising natamycin and at least one insecticide according to the invention for the protection of a plant, or a part of a plant, against a pathogen. In order to achieve this effect, said plant or plant part, or a soil, is contacted with said natamycin and an insecticide that interferes with the nervous system and/or muscular system of insects and nematodes, preferably with said composition, including the diluted aqueous composition as described herein above. Said natamycin and an insecticide that interferes with the nervous system and/or muscular system of insects and nematodes, preferably said composition, is used, for example, to control powdery mildew and Botrytis infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, Fusarium diseases, peanut leafspot, and mildew on roses. Other uses include protection of greenhouse grown flowers and ornamentals, home vegetable gardens and residential turf. In addition, said natamycin and an insecticide that interferes with the nervous system and/or muscular system of insects and nematodes, preferably said composition, including a diluted aqueous composition, may be contacted with isolated seeds, fruits, nuts, vegetables, and/or flowers.

The invention further provides a method of protecting a plant or plant part against a pathogen, comprising contacting said plant or said plant part with natamycin and an insecticide that interferes with the nervous system and/or muscular system of insects and nematodes, preferably with a diluted aqueous composition according to this invention comprising natamycine and a nerve and muscle insecticide, preferably an insecticide of subgroup 2, 3, 4, 6 and/or 28, which subgroups are identified in the document “IRAC Mode of Action Classification Scheme”.

The invention further provides a method of preventing, reducing and/or eliminating the presence of a pathogen on a plant, or a part of a plant, comprising contacting said plant, or part of said plant, with natamycin and an insecticide that interferes with the nervous system and/or muscular system of insects and nematodes, preferably with an aqueous composition according to this invention.

For said use and said methods, the natamycin and insecticide that interferes with the nervous system and/or muscular system of insects and nematodes, preferably said composition, including a diluted aqueous composition, is preferably sprayed over a plant, or part thereof. Spraying applications, including the use of automatic spraying systems are known to reduce labor costs and are cost-effective. Methods and equipment well-known to a person skilled in the art can be used for that purpose. The natamycin and insecticide that interferes with the nervous system and/or muscular system of insects and nematodes, preferably said composition, including diluted aqueous composition, can regularly be sprayed, when the risk of infection is high. When the risk of infection is lower, spray intervals may be longer, as is known to a person skilled in the art.

Other methods suitable for contacting plants or parts thereof with natamycin and an insecticide that interferes with the nervous system and/or muscular system of insects and nematodes, preferably with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, natamycin and an insecticide that interferes with the nervous system and/or muscular system of insects and nematodes, preferably the composition of the invention, including a diluted aqueous composition, may be injected into the soil.

For example, a plant of part thereof may be coated with natamycin and an insecticide that interferes with the nervous system and/or muscular system of insects and nematodes, preferably with a diluted aqueous composition comprising natamycin and at least one insecticide according to the invention by submerging the plant or part thereof in natamycin and an insecticide that interferes with the nervous system and/or muscular system of insects and nematodes, preferably in a diluted aqueous composition according to the invention, to protect the plant of part thereof against a pathogen and/or to prevent, reduce and/or eliminate the presence of a pathogen on a plant, or a part of a plant.

A preferred part of a plant that is treated with natamycin and an insecticide that interferes with the nervous system and/or muscular system of insects and nematodes, preferably with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

A further preferred part of a plant that is treated with natamycin and an insecticide that interferes with the nervous system and/or muscular system of insects and nematodes, preferably with a composition according to the invention, or with a dilution thereof, is a vegetable. Said vegetable preferably is selected from lettuce, tomato, pepper, especially sweet pepper, eggplant, and brassica vegetables such as mustard, kale, cabbage, collard greens, broccoli, cauliflower, kai-lan, Brussels sprouts, and kohlrabi.

The invention further provides a method of controlling diseases caused by phytopathogenic fungi in plants or on propagation material thereof, which method comprises contacting the plants, or propagation material thereof, with a natamycin and an insecticide that interferes with the nervous system and/or muscular system of insects and nematodes, preferably with a composition according to the invention, including an aqueous diluted composition.

The present invention also provides a method of controlling pests comprising contacting (i) a pest or a locus thereof, (ii) a plant or a locus or propagation material thereof, (iii) soil, and/or (iv) an area in which a pest infestation is to be prevented with natamycin and an insecticide that interferes with the nervous system and/or muscular system of insects and nematodes, preferably with a composition comprising natamycin and at least one insecticide of the invention.

The present invention also provides a method for improving pest control comprising applying natamycin and an insecticide that interferes with the nervous system and/or muscular system of insects and nematodes, preferably a composition described herein to a plant/or soil.

The present invention also provides a method for prolonging a controlling effect of natamycin on a plant, plant part of soil, comprising applying natamycin and an insecticide that interferes with the nervous system and/or muscular system of insects and nematodes, preferably a composition of the invention or dilution thereof, to the plant, plant part or soil.

In some embodiments, the target is a plant, plant part, soil or growth substrate. In some embodiments, the target is a fungus.

The present invention also provides a method for pest control by preventive, curative or persistence treatment of a plant disease caused by phytopathogenic fungi comprising contacting a plant, a locus thereof or propagation material thereof with an effective amount of natamycin and an insecticide that interferes with the nervous system and/or muscular system of insects and nematodes, preferably with a composition comprising natamycin and at least one insecticide according to the invention.

The described compositions comprising natamycin and at least one insecticide according to the invention may be applied to healthy or diseased plants. The described compositions can be used on various plants including but not limited to crops, seeds, bulbs, propagation material, or ornamental species.

The present invention provides a method of controlling a disease caused by phytopathogenic fungi on plants or propagation material thereof, comprising contacting the plants, the locus thereof or propagation material thereof with natamycin and an insecticide that interferes with the nervous system and/or muscular system of insects and nematodes, preferably with a composition comprising natamycin and at least one insecticide according to the invention.

In some embodiments, the fungus is one of Leaf Blotch of Wheat (Mycosphaerella graminicola; anamorph: Septoria tritici), Wheat Brown Rust (Puccinia triticina), Botrytis cinerea on grapevine, Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

In some embodiments, natamycin and an insecticide that interferes with the nervous system and/or muscular system of insects and nematodes, preferably the composition comprising natamycin and at least one insecticide according to the invention, is applied at a rate effective for controlling a pest. In some embodiments, natamycin and an insecticide that interferes with the nervous system and/or muscular system of insects and nematodes, preferably the composition comprising natamycin and at least one insecticide according to the invention is applied at a rate effective for preventing infestation of the pest. In some embodiments, natamycin and an insecticide that interferes with the nervous system and/or muscular system of insects and nematodes, preferably the composition comprising natamycin and at least one insecticide according to the invention is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of natamycin. In some embodiments, the method is effective for prolonging the pesticidal effect of the natamycin.

In some embodiments, a method of the invention is effective for decreasing the half maximal effective concentration (EC50) of natamycin. In some embodiments, the method is effective for decreasing the EC50 by at least 10%. In some embodiments, the method is effective for decreasing the EC50 by at least 25%. In some embodiments, the method is effective for decreasing the EC50 by at least 35%. In some embodiments, the method is effective for decreasing the EC50 by at least 50%.

In some embodiments, a method of the invention is effective for decreasing the LC50 of natamycin. In some embodiments, the method is effective for decreasing the LC50 by at least 10%. In some embodiments, the method is effective for decreasing the LC50 by at least 25%. In some embodiments, the method is effective for decreasing the LC50 by at least 50%. In some embodiments, the method is effective for decreasing the LC50 by at least 75%. In some embodiments, the method is effective for decreasing the LC50 by at least 90%.

In some embodiments, a method of the invention is effective for decreasing the LC90 of natamycin. In some embodiments, the method is effective for decreasing the LC90 by at least 10%. In some embodiments, the method is effective for decreasing the LC90 by at least 25%. In some embodiments, the method is effective for decreasing the LC90 by at least 50%. In some embodiments, the method is effective for decreasing the LC90 by at least 75%. In some embodiments, the method is effective for decreasing the LC90 by at least 90%.

In some embodiments, a method of the invention further comprises applying at least one additional agrochemical to a pest, a plant part, a plant, the locus, or propagation material thereof. Said additional agrochemical may be admixed in a tank, or applied sequentially with natamycin and an insecticide that interferes with the nervous system and/or muscular system of insects and nematodes, preferably with the composition comprising natamycin and at least one insecticide to the plants, plant parts, soil or growth substrate.

The invention is illustrated by the following examples without limiting it thereby.

### EXAMPLES

### General

### 1. Natamycin Formulation Used in the Experiments.

Natamycin was tested in different test systems at different concentrations as indicated in each example. Natamycin was formulated as shown in Table 1.

TABLE 1
Natamycin formulation used in the examples. Provided are the
range of ingredients used in the different experiments.

| Formulation | Gram/Liter |
|---|---|
| Natamycin | 150 |
| Polyol | 175-300 |
| Wetting agent | 20-30 |
| Dispersing agent | 5-15 |
| Anti foam | 0.5-10 |
| Mixture of isothiazolinones | 0.05-0.3 |
| Xanthan gum (2% in water) | 70-85 |
| Water | 509.7-679.45 |
| Total | 1100 |

### 2. Insecticide Formulations Used in the Experiments.

The insecticidal active ingredients Thiamethoxam (Merck; 37924), and Imidacloprid (Merck; 37894), Abamectin (Merck; 31732) were formulated in the compositions as presented in Table 2.

TABLE 2
Insecticide formulations of Thiamethoxam (SyngentaGroup, Basel,
Switzerland), Imidacloprid (Simonis B. V. Doetinchem, the
Netherlands), and Abamectin (Simonis B. V. Doetinchem, the
Netherlands), that were used for the active ingredients.

| | [%] |
|---|---|
| Thiamethoxam Composition | |
| Thiamethoxam | 10.24 |
| Water | 89.76 |
| Total | 100.0 |
| Imidacloprid Composition | |
| Imidacloprid | 39.9 |
| Atlox 4913 | 2.2 |
| Atlox 4894 | 2.2 |
| Cresmer ad09 | 0.1 |
| Proxel GXL | 0.2 |
| Xanthan gum | 0.4 |
| Propylene glycol | 5.2 |
| Water | 50.0 |
| Total | 100.0 |
| Abamectin Composition | |
| Abamectin | 18.0 |
| Atlox 4838B | 9.0 |
| Etocas 10 | 2.8 |
| Etocas 35 | 2.8 |
| N.N-Dimethylformamide | 10.0 |
| N-Methyl-2-pyrrolidone | 57.5 |
| Total | 100.0 |

For the active ingredients fipronil, lambda-cyhalothrin, alpha-cypermethrin, emamectin benzoate, chlorantraniliprole, hydroprene, chlorfenapyr and azadirachtin commercial products were used as mentioned in the examples.

### 3. Determination of Synergy

In some instances, the stimulation of the antifungal activity of natamycin by an insecticide was found to be synergistic. The Colby equation (Colby, 1967. Weeds 15:20-22) calculates the expected antifungal activity (E in %) of a combination comprising more than one active ingredients:

$$E = X + Y - [ ( X \cdot Y ) / 100 ]$$

wherein X and Y are the observed antifungal activities (in %) of the individual active ingredients x and y, respectively. If the observed antifungal activity (O in %) of the combination exceeds the expected antifungal activity (E in %) of the combination and the synergy factor O/E is thus >1.0, the combined application of the active ingredients leads to a synergistic antifungal effect.

### Example 1: Antifungal Effect of Natamycin in Combination with Lambda Cyhalothrin Against Sclerotinia sclerotiorum on Organic Broad Bean Pods

In this example the product KARATE ZEON® of Syngenta containing the active ingredient lambda-cyhalothrin belonging to IRAC Group 3 was tested for interaction with natamycin.

### Material and Methods

### Tested Plant Material: Pods of Broad Beans.

### Tested Treatments:

1) Control (without natamycin and lambda-cyhalothrin)
2) Natamycin at a level of 15 ppm
3) Lambda-cyhalothrin (in the product KARATE ZEON® of Syngenta) at a levels of 0.15 ppm, 0.6 ppm, 3 ppm and 15 ppm
4) Natamycin at a level of 15 ppm combined with lambda-cyhalothrin at levels of 0.15 ppm, 0.6 ppm, 3 ppm or 15 ppm.

Used pathogen: Sclerotinia sclerotiorum.

Application: The broad bean pods were washed under tap water, and were subsequently surface sterilized by placing them in a 0.1% sodium hypochlorite solution for 5 minutes. The pods were then rinsed with tap water and dried. Transparent plastic containers were prepared by placing a piece of absorbing paper in the container and adding 25 ml of water, one container per treatment was used. The pods were cut in two, and two halve pods were incubated per box. The skin of broad bean pods was damaged with a needle, ø 2 mm and to a depth of about 3 mm into the fruit, with—depending on the size of the pod—2 to 4 wounds per half pod. In total, 6 wounds were incubated per treatment, of which 1 was used as a control. A volume of 20 microliter of a natamycin/insecticide composition, as presented herein above, was applied by pipette to each wound. The treatments were then left to air-dry. Once dried, a mycelium plug of Sclerotinia sclerotiorum was placed upside down on each wound, so that the mycelium was in direct contact with the wound. Per treatment 5 wounds were inoculated with the fungus, while the 6^{th} and last wound was used as negative non-inoculated control. After inoculation, the containers were directly closed with a transparent plastic lid.

All pods were kept at room temperature (20° C.). Wounds of the pods were checked after 30 h of incubation. The recorded of antifungal activity was the surface area (square mm) of the rot around the infection spots for the broad bean pods, compared to the untreated control (see Table 3).

Replicates: All treatments for the broad bean pod experiment were performed on two individual pod halves resulting in 5 wounds per treatment, while a sixth wound served as control.

### Results

As is shown in Table 3, lambda-cyhalothrin synergistically enhances the efficacy of natamycin against Sclerotinia sclerotiorum at ratios (natamycin:lambda-cyhalothrin) between 1:1 and 25:1.

TABLE 3
Antifungal effect of natamycin in combination with lambda-
cyhalothrin in the product KARATE ZEON ® of Syngenta
against Sclerotinia sclerotiorum infection tested on the
skin of broad bean pods. Assessment of the infection area
was 30 h after inoculation. Experiment was performed in 5-fold.

| | Avg | | | | |
|---|---|---|---|---|---|
| Natamycin - | infected | | | | |
| insecticide | area | Observed | Expected | | |
| (ppm) | (mm²) | (%) | (%) | O/E | Interaction |
| 0-0 | 314.41 | 0.00 | | | |
| 15-0 | 278.54 | 11.4 | | | |
| 0-15 | 322.41 | −2.5 | | | |
| 0-3 | 350.24 | −11.4 | | | |
| 0-0.6 | 325.88 | −3.7 | | | |
| 0-0.15 | 314.73 | −0.1 | | | |
| 15-15 | 256.29 | 18.5 | 9.2 | 2.0 | Synergism |
| 15-3 | 268.08 | 14.7 | 1.3 | 11.2 | Synergism |
| 15-0.6 | 278.11 | 11.6 | 8.2 | 1.4 | Synergism |
| 15-0.15 | 309.45 | 1.6 | 11.3 | 0.1 | No synergism |

### Example 2. Antifungal Effect of Natamycin in Combination with Hydroprene Against Sclerotinia sclerotiorum on Broad Bean Pods

In this example the product GENTROL® (Zoëcon/Central Life Sciences, Schaumburg, IL, USA) containing the active ingredient hydroprene belonging to IRAC Group 7 was tested.

### Materials and Methods

The experiments were performed as described in Example 1.

### Results

Results are presented in Table 4. It is concluded that natamycin and hydroprene do not have a synergistic combined effect against the fungus Sclerotinia sclerotiorum.

TABLE 4
Antifungal effect of natamycin in combination with hydroprene
against Sclerotinia sclerotiorum infection on the skin
of broad bean pods. Assessment of the infection area was 23
h after inoculation. Experiment was performed in 5-fold.

| | Avg | | | | |
|---|---|---|---|---|---|
| Natamycin - | infected | | | | |
| insecticide | area | Observed | Expected | | |
| (ppm) | (mm2) | % | % | O/E | |
| 0-0 | 156.7 | 0.0 | | | |
| 15-0 | 104.2 | 33.5 | | | |
| 0-15 | 89 | 43.2 | | | |
| 0-3 | 74.5 | 52.5 | | | |
| 0-0.6 | 103.1 | 34.2 | | | |
| 0-0.15 | 99.3 | 36.6 | | | |
| 15-15 | 68 | 56.6 | 62.2 | 0.9 | No synergism |
| 15-3 | 97.4 | 37.8 | 68.4 | 0.6 | No synergism |
| 15-0.6 | 106 | 32.4 | 56.3 | 0.6 | No synergism |
| 15-0.15 | | 36.2 | 57.9 | 0.6 | No synergism |

### Example 3. Effect of Hydroprene on Natamycin Efficacy on Fusarium graminerum Tested on Petri Dishes

In this experiment, the product GENTROL® (Zoëcon/Central Life Sciences, Schaumburg, IL, USA) containing the active ingredient hydroprene belonging to IRAC Group 7 was tested.

### Materials and Methods

Agar medium was prepared by mixing in a 100 ml Duran bottle 3.9 g of potato dextrose agar (PDA) from Carl-Roth (Carl-Roth GmbH+Co. KG, Karlsruhe, Germany) with 100 ml deionized water and autoclaving the Duran bottle at 120° C. for 15 minutes. After autoclaving, the solution was cooled by putting it in a 48° C. oven for about two hours. Afterward the semi-liquid PDA solution was carefully mixed with natamycin and/or insecticide dosages as specified in Table 5 showing the interaction results on petri dishes. The medium in the Duran bottle was divided over 5 petri dishes (90×15 mm), 20 ml per petri dish by using 25 ml serological pipets (ROTILABO®; Carl-Roth). Each natamycin and/or insecticide treatment was performed in fivefold.

Fungal spore suspensions were prepared by drenching a fully grown petri dish with sterile water. The fungus was scraped off and filtered through a Miracloth (pore size: 22-25 μm) (Merck KGaA, Darmstadt, Germany; catalogue number: 475855). The number of spores were counted with a hemocytometer and fungal suspension was adjusted to 10⁶ spores per ml. Afterward, 5 μl of prepared spore suspension was pipetted on the center of the agar plate. The plates were incubated at 25° C. Measurement of the fungal growth was done using callipers at different time points. Assessment of the infection area was 6 days after inoculation.

The insecticide levels and the period after which the assessments were made are presented as specified for the different insecticides are presented in Table 5 below. Synergistic calculation was done using the Colby equation. Experiment was performed in 5-fold.

TABLE 5
Antifungal effect of natamycin in combination with hydroprene
(GENTROL ®) against Fusarium graminerum infection
tested on petri dishes.

| | Avg | | | | |
|---|---|---|---|---|---|
| Natamycin - | infected | | | | |
| insecticide | area | Observed | Expected | | |
| (ppm) | (mm2) | % | % | O/E | Interaction |
| 0-0 | 1135.6 | 0.0 | | | |
| 0.5-0 | 1054.4 | 7.2 | | | |
| 0-0.05 | 1124 | 1.0 | | | |
| 0-0.1 | 1142.1 | −0.6 | | | |
| 0-0.2 | 970.5 | 14.5 | | | |
| 0-0.5 | 1055.1 | 7.1 | | | |
| 0.5-0.05 | 1103.3 | 2.9 | 8.1 | 0.4 | No synergism |
| 0.5-0.1 | 1100.8 | 3.1 | 6.6 | 0.5 | No synergism |
| 0.5-0.2 | 1094.6 | 3.6 | 20.7 | 0.2 | No synergism |
| 0.5-0.5 | 1059.2 | 6.7 | 13.7 | 0.5 | No synergism |

### Results

Results are presented in Table 5.

It is concluded that a combination of natamycin and hydroprene does not have a synergistic effect against the fungus Fusarium graminerum.

### Example 4. Antifungal Effect of Natamycin in Combination with Hydroprene Against Fusarium culmorum Tested on Petri Dishes

The product GENTROL® (Zoëcon/Central Life Sciences, Schaumburg, IL, USA) containing the active ingredient hydroprene belonging to IRAC Group 7 was tested.

### Material and Methods

The experiments were performed as described in Example 3. Assessment of the infection area was 6 days after inoculation. Experiment was performed in 5-fold.

### Results

Results are presented in Table 6. It is concluded that natamycin and hydroprene do not have a synergistic combined effect against the fungus Fusarium culmorum.

TABLE 6
Antifungal effect of natamycin in combination with hydroprene
against Fusarium culmorum infection tested on petri dishes.

| | Avg | | | | |
|---|---|---|---|---|---|
| Natamycin - | infected | | | | |
| insecticide | area | Observed | Expected | | |
| (ppm) | (mm2) | % | % | O/E | Interaction |
| 0-0 | 998.2 | 0.0 | | | |
| 0.5-0 | 810.2 | 18.8 | | | |
| 0-0.05 | 934.7 | 6.4 | | | |
| 0-0.1 | 1010.5 | −1.2 | | | |
| 0-0.2 | 1014.3 | −1.6 | | | |
| 0-0.5 | 1060.2 | −6.2 | | | |
| 0.5-0.05 | 1128.8 | −13.1 | 24.0 | −0.5 | No synergism |
| 0.5-0.1 | 888.2 | 11.0 | 17.8 | 0.6 | No synergism |
| 0.5-0.2 | 917.3 | 8.1 | 17.5 | 0.5 | No synergism |
| 0.5-0.5 | 876.9 | 12.2 | 13.8 | 0.9 | No synergism |

### Example 5. Antifungal Effect of Azadirachtin on Natamycin Efficacy on Sclerotinia sclerotiorum Tested on Broad Beans (Post-Harvest Test)

The product AZATIN® (Certis, Columbia, USA) containing the active ingredient azadirachtin belonging to IRAC Group UN (compounds of unknown or uncertain mode of action) was tested.

### Material and Methods

The experiments were performed as described in Example 1. Assessment of the infection area was 23 h after inoculation. Experiment was performed in 5-fold.

### Results

Results are presented in Table 7. In conclusion, natamycin and azadirachtin do not have a synergistic combined effect against the fungus Sclerotinia sclerotiorum.

TABLE 7
Antifungal effect of natamycin in combination with
azadirachtin against Sclerotinia sclerotiorum infection
tested on the skin of broad bean pods.

| | Avg | | | | |
|---|---|---|---|---|---|
| Natamycin - | infected | | | | |
| insecticide | area | Observed | Expected | | |
| (ppm) | (mm2) | % | % | O/E | Interaction |
| 0-0 | 136.7 | 0.0 | | | |
| 15-0 | 99.9 | 26.9 | | | |
| 0-15 | 123.1 | 9.9 | | | |
| 0-3 | 98.3 | 28.1 | | | |
| 0-0.6 | 82.0 | 40 | | | |
| 0-0.15 | 80.2 | 41.3 | | | |
| 15-15 | 144.4 | −5.6 | 34.1 | −0.2 | No synergism |
| 15-3 | 99.3 | 27.3 | 47.4 | 0.6 | No synergism |
| 15-0.6 | 115.2 | 15.7 | 56.1 | 0.3 | No synergism |
| 15-0.15 | 124.1 | 9.2 | 57.1 | 0.2 | No synergism |

### Example 6. Antifungal Effect of Natamycin in Combination with Thiamethoxam Against Sclerotinia sclerotiorum Infection Tested on the Skin of Broad Bean Pods

### Material and Methods

The experiments were performed as described in Example 1. The formulation of the thiamethoxam composition is presented in Table 2. Thiamethoxam belongs to IRAC Group 4. Assessment of the infection area was 31 hours after inoculation. Experiment was performed in 5-fold.

### Results

Results are presented in Table 8. It is concluded that thiamethoxam synergistically enhances the efficacy of natamycin against Sclerotinia sclerotiorum at ratios of 1:1, 5:1, and 25:1.

TABLE 8
Antifungal effect of natamycin in combination with
thiamethoxam against Sclerotinia sclerotiorum infection
tested on the skin of broad bean pods.

| | Avg | | | | |
|---|---|---|---|---|---|
| Natamycin - | infected | | | | |
| insecticide | area | Observed | Expected | | |
| (ppm) | (mm2) | % | % | O/E | Interaction |
| 0-0 | 258.2 | 0.0 | | | |
| 15-0 | 172.7 | 33.1 | | | |
| 0-15 | 254.1 | 1.6 | | | |
| 0-3 | 253.2 | 1.9 | | | |
| 0-0.6 | 270.9 | −4.9 | | | |
| 0-0.15 | 250.6 | 2.9 | | | |
| 15-15 | 165.3 | 36 | 34.2 | 1.1 | Synergism |
| 15-3 | 136.0 | 47.3 | 34.4 | 1.4 | Synergism |
| 15-0.6 | 175.7 | 32 | 29.8 | 1.1 | Synergism |
| 15-0.15 | 201.2 | 22.1 | 35.1 | 0.6 | No synergism |

### Example 7. Antifungal Effect of Natamycin in Combination with Chlorfenapyr Against Sclerotinia sclerotiorum Infection Tested on the Skin of Broad Bean Pods

### Material and Methods

The experiments were performed as described in Example 1. The product SPECTRE® of company (Adama) containing the active ingredient chlorfenapyr belonging to IRAC Group 13 was tested. Assessment of the infection area was 23 hours after inoculation. Experiment was performed in 5-fold.

### Results

Results are presented in Table 9. It is concluded that natamycin and chlorfenapyr do not have a synergistic combined effect against the fungus Sclerotinia sclerotiorum.

TABLE 9
Antifungal effect of natamycin in combination with chlorfenapyr
(in the product SPECTRE ®) against Sclerotinia sclerotiorum
infection tested on the skin of broad bean pods.

| Natamycin-insecticide | Avg infected | Observed | Expected | | |
|---|---|---|---|---|---|
| (ppm) | area (mm2) | % | % | O/E | Interaction |
| 0-0 | 113.7 | 0.00 | | | |
| 15-0 | 66.2 | 41.8 | | | |
| 0-15 | 94.9 | 16.5 | | | |
| 0-3 | 92.3 | 18.8 | | | |
| 0-0.6 | 71.3 | 37.3 | | | |
| 0-0.15 | 86.9 | 23.6 | | | |
| 15-15 | 75.0 | 34.1 | 51.45 | 0.7 | No synergism |
| 15-3 | 75.9 | 33.3 | 52.79 | 0.6 | No synergism |
| 15-0.6 | 62.2 | 45.4 | 63.54 | 0.7 | No synergism |
| 15-0.15 | 61.8 | 45.68 | 55.53 | 0.82 | No synergism |

### Example 8. Antifungal Effect of Natamycin in Combination with Lambda-Cyhalothrin Against Fusarium Graminerum Tested on Petri Dishes

### Material and Methods

The experiments were performed as described in Example 3. The product KARATE ZEON® of company Syngenta containing the active ingredient lambda-cyhalothrin belonging to IRAC Group 3 was tested. Assessment of the infection area was 6 days after inoculation. Experiment was performed in 5-fold.

### Results

Results are presented in Table 10. It is concluded that natamycin and lambda-cyhalothrin have a synergistic combined effect against the fungus Fusarium graminerum at the ratios of natamycin:lambda-cyhalothrin of 1:1 to 10:1.

TABLE 10
Antifungal effect of natamycin in combination with lambda-
cyhalothrin (in the product KARATE ZEON ®) against
Fusarium graminerum infection tested on petri dishes.

| Natamycin-insecticide | Avg infected | Observed | Expected | | |
|---|---|---|---|---|---|
| (ppm) | area (mm2) | % | % | O/E | Interaction |
| 0-0 | 3614.7 | 0.0 | | | |
| 1-0 | 1107.7 | 69.4 | | | |
| 0-0.1 | 4846.2 | −34.1 | | | |
| 0-0.2 | 5071.1 | −40.3 | | | |
| 0-0.5 | 4842.3 | −34 | | | |
| 0-1 | 4714.2 | −30.4 | | | |
| 1-0.1 | 1291.1 | 64.3 | 58.9 | 1.1 | Synergism |
| 1-0.2 | 866.3 | 76.0 | 57.0 | 1.3 | Synergism |
| 1-0.5 | 894 | 75.3 | 59 | 1.3 | Synergism |
| 1-1 | 1326.1 | 63.3 | 60.0 | 1.1 | Synergism |

### Example 9. Antifungal Effect of Natamycin in Combination with Lambda-Cyhalothrin Against Fusarium culmorum Tested on Petri Dishes

### Material and Methods

The experiments were performed as described in Example 3. The product KARATE ZEON® of company Syngenta containing the active ingredient lambda-cyhalothrin belonging to IRAC Group 3 was tested. Assessment of the infection area was 3 days after inoculation. Experiment was performed in 5-fold.

### Results

Results are presented in Table 11. It is concluded that natamycin and lambda-cyhalothrin have a synergistic combined effect against the fungus Fusarium graminerum at the ratios of natamycin:lambda-cyhalothrin of 1:1, 2.5:1 and 5:1.

TABLE 11
Antifungal effect of natamycin in combination with lambda-
cyhalothrin (in the product KARATE ZEON ®) against
Fusarium culmorum infection tested on petri dishes.

| Natamycin-insecticide | Avg infected | Observed | Expected | | |
|---|---|---|---|---|---|
| (ppm) | area (mm2) | % | % | O/E | Interaction |
| 0-0 | 362.7 | 0.0 | | | |
| 0.5-0 | 297.7 | 17.9 | | | |
| 0-0.05 | 384.0 | −5.9 | | | |
| 0-0.1 | 383.9 | −5.8 | | | |
| 0-0.2 | 370.9 | −2.2 | | | |
| 0-0.5 | 381.7 | −5.2 | | | |
| 0.5-0.05 | ND | | | | ND |
| 0.5-0.1 | 275.5 | 24.0 | 13.2 | 1.8 | Synergism |
| 0.5-0.2 | 271.0 | 25.3 | 16.1 | 1.6 | Synergism |
| 0.5-0.5 | 284.97 | 21.4 | 13.6 | 1.6 | Synergism |

ND: Not determined

### Example 10. Antifungal Effect of Natamycin in Combination with Lambda-Cyhalothrin Against Botrytis cinerea on Tested on Banana Fruits

In this example the product KARATE ZEON® of company Syngenta containing the active ingredient lambda-cyhalothrin belonging to IRAC Group 3 was used. The infection area was measured 5 days after inoculation.

### Material and Methods

The experiments were performed as described in Example 1, but instead of broad bean pods, banana fruits were used (the peel of the banana fruit was punctured with a needle (diameter of 2 mm)). The bananas were surface sterilized and placed in transparent plastic containers prepared as described in Example 1. A few changes were made for the banana experiments: 5 wounds per banana were made, on each wound 40 microliter of treatments was pipetted. The treatments were then left to air-dry. Once dried, 2 microliter of a freshly prepared inoculum was pipetted on four of the wounds. The inoculum consists of 14 potato dextrose broth (PDB) medium containing Botrytis cinerea spores at a concentration of 10⁶ spores per ml. The fifth wound was used as negative non-inoculated control. Experiment was performed in 4-fold.

### Results

Results are presented in Table 12A and Table 12B. It is concluded that a synergistic interaction in efficacy against a pathogenic fungus was observed, at a ratio of ratio natamycin:λ-cyhalothrin ratios of 1:1 to 100:1.

Since the ratio natamycin:lambda-cyhalothrin 100:1 (Table 12A) was still synergistic, the ratio of 250:1 was also tested (see Table 12B).

TABLE 12A
Antifungal effect of natamycin in combination with Lambda
cyhalothrin (in the product KARATE ZEON ®) against
Botrytis cinerea infection tested on the peel of banana fruits.

| Natamycin-insecticide | Avg infected | Observed | Expected | | |
|---|---|---|---|---|---|
| (ppm) | area (mm2) | % | % | O/E | Interaction |
| 0:0 | 63.9 | 0.0 | | | |
| 1:0 | 52.6 | 18.0 | | | |
| 0:1 | 41.8 | 34.6 | | | |
| 0:0.04 | 55.1 | 13.7 | | | |
| 0:0.01 | 38.9 | 39.0 | | | |
| 1:1 | 11.9 | 81.4 | 46.4 | 1.8 | Synergism |
| 1:0.04 | 11.7 | 81.6 | 29.3 | 2.8 | Synergism |
| 1:0.01 | 9.1 | 85.8 | 50.0 | 1.7 | Synergism |

TABLE 12B
Antifungal effect of natamycin in combination with Lambda-cyhalothrin
(in the product KARATE ZEON ®) against Botrytis cinerea infection
tested on the peel of banana fruits. Assessment of the infection area
5 days after inoculation. Experiment was performed in 4-fold.

| Natamycin-insecticide | Avg infected | Observed | Expected | | |
|---|---|---|---|---|---|
| (ppm) | area (mm2) | % | % | O/E | Interaction |
| 0:0 | 98.8 | 0.0 | | | |
| 1:0 | 84.7 | 14.3 | | | |
| 0:0.004 | 82.4 | 16.6 | | | |
| 1:0.004 | 134.9 | −36.6 | 28.5 | −1.3 | No synergism |

### Example 11. Antifungal Effect of Natamycin in Combination with Emamectin Benzoate Against a Colletotrichum Species

In this experiment, the product OPTIGARD® Cockroach of company Syngenta containing the active ingredient emamectin benzoate belonging to IRAC Group 6 was tested.

### Material and Methods

The experiments were performed as described in Example 1, but instead of broad bean red pepper was used. For the treatment, 5 wounds per pepper side were done as previously described. In addition, one wound was done as negative control. Depending on the number of sides of the pepper, 3 to 4 treatments were done per paprika. Per wound 10 μl of treatment was placed on the wound. The treatments were let to dry in a down flow cabinet for about 30 minutes. After drying 5 μl spore suspension at a concentration of 10\hat{ }7 spores per ml were placed on the wounds. The fungus was isolated from Colletotrichum-infected plant material and identified using techniques known to the person skilled in the art. The pepper were placed as described previously in a transparent container, with the difference that the containers were then placed in a transparent plastic zipper bag. The bags with peppers were placed at room temperature and in the dark for two days. After that the size of the lesions were measured. Assessment of the infection area was 4 days after inoculation. Experiment was performed in 5-fold.

### Results

Results are presented in Table 13. natamycin and emamectin benzoate have a synergistic combined effect against the fungus Colletotrichum at ratio's 1:1 to 25:1.

TABLE 13
Antifungal effect of natamycin in combination with emamection benzoate against
Colletotrichum spp. infection tested on the skin of pepper fruits.

| Natamycin-insecticide | Avg infected | Observed | Expected | | |
|---|---|---|---|---|---|
| (ppm) | area (mm2) | % | % | O/E | Interaction |
| 0:0 | 16.1 | 0.0 | | | |
| 1:0 | 10.6 | 33.8 | | | |
| 0:1 | 24 | −49.1 | | | |
| 0:0.04 | 16.6 | −3.5 | | | |
| 0:0.01 | 30.6 | −90.1 | | | |
| 1:1 | 11.3 | 29.5 | 1.4 | 21.6 | Synergism |
| 1:0.04 | 8.4 | 48.1 | 31.5 | 1.5 | Synergism |
| 1:0.01 | 6.5 | 59.7 | −25.8 | −2.3 | No synergism |

### Example 12. Antifungal Effect of Natamycin in Combination with Alpha-Cypermethrin Against Botrytis cinerea on Tested on Banana Fruits

In this experiment, the product CYPERKILL® (Arysta, Tokyo, Japan) containing the active ingredient cypermethrin belonging to IRAC Group 3 was tested.

### Material and Methods

The experiments were performed as described in Example 10. Assessment of the infection area was performed 3 days after inoculation. Experiment was performed in 4-fold.

### Results

Results are presented in Tables 14A and 14B. It was concluded that natamycin and cypermethrin have a synergistic combined effect against the fungus Botrytis cinerea at ratio's between 1:1 to 100:1.

TABLE 14A
Antifungal effect of natamycin in combination with alpha-cypermethrin against
Botrytis cinerea infection tested on the peel of banana fruits.

| Natamycin-insecticide | Avg infected | Observed | Expected | | |
|---|---|---|---|---|---|
| (ppm) | area (mm2) | % | % | O/E | Interaction |
| 0:0 | 11.3 | 0.0 | | | |
| 1:0 | 9.2 | 18.8 | | | |
| 0:1 | 9.9 | 12.8 | | | |
| 0:0.04 | 9.1 | 19.8 | | | |
| 0:0.01 | 9.0 | 20.5 | | | |
| 1:1 | 5.6 | 50.8 | 29.2 | 1.7 | Synergism |
| 1:0.04 | 6.6 | 41.6 | 34.8 | 1.2 | Synergism |
| 1:0.01 | 5.6 | 50.3 | 35.4 | 1.4 | Synergism |

Since the ratio natamycin:cypermethrin 100:1 was still synergistic, the ratio of 250:1 was also tested.

TABLE 14B
Antifungal effect of natamycin in combination with alpha-cypermethrin
(in the product CYPERKILL) against Botrytis cinerea infection
tested on the peel of banana fruits. Assessment of the infection
area 3 days after inoculation. Experiment in 4-fold.

| Natamycin-insecticide | Avg infected | Observed | Expected | | |
|---|---|---|---|---|---|
| (ppm) | area (mm2) | % | % | O/E | Interaction |
| 0:0 | 9.8 | 0.0 | | | |
| 1:0 | 5.5 | 43.9 | | | |
| 0:0.004 | 6.2 | 37.2 | | | |
| 1:0.004 | 5.5 | 44.1 | 64.8 | 0.7 | No synergism |

### Example 13. Antifungal Effect of Natamycin in Combination with Alpha-Cypermethrin Against Colletotrichum Spp. On the Skin of Pepper Fruits

In this experiment, the product CYPERKILL® of company Arysta containing the active ingredient cypermethrin belonging to IRAC Group 3 was tested.

### Material and Methods

The experiments were performed as described in Example 11. The fungus was isolated from Colletotrichum-infected plant material and identified using techniques known to the person skilled in the art. Assessment of the infection area was performed 5 days after inoculation. Experiment was performed in 5-fold.

### Results

Results are presented in Table 15. It was concluded that natamycin and alpha-cypermethrin have a synergistic combined effect against the fungus Colletotrichum at ratio's between 1:1 to 100:1.

TABLE 15
Antifungal effect of natamycin in combination with alpha-cypermethrin against
Colletotrichum infection tested on the skin of pepper fruits.

| Natamycin-insecticide | Avg infected | Observed | Expected | | |
|---|---|---|---|---|---|
| (ppm) | area (mm2) | % | % | O/E | Interaction |
| 0:0 | 42.2 | 0.0 | | | |
| 1:0 | 30.2 | 28.6 | | | |
| 0:1 | 20.6 | 51.2 | | | |
| 0:0.04 | 22.5 | 46.7 | | | |
| 0:0.01 | 44.8 | −6.1 | | | |
| 1:1 | 8.1 | 80.9 | 65.2 | 1.2 | Synergism |
| 1:0.04 | 6.4 | 84.8 | 61.9 | 1.4 | Synergism |
| 1:0.01 | 12.7 | 69.9 | 24.2 | 2.9 | Synergism |

### Example 14. Antifungal Effect of Natamycin in Combination with Imidacloprid Against Colletotrichum Infection Tested on the Skin of Pepper Fruits

### Material and Methods

The experiments were performed as described in Example 11. The active ingredient imidacloprid was formulated as described in Table 2. Imidacloprid belonging to IRAC Group 4. The fungus was isolated from Colletotrichum-infected plant material and identified using techniques known to the person skilled in the art. Assessment of the infection area was performed 5 days after inoculation. Experiment was performed in 5-fold.

### Results

Results are presented in Table 16. It was concluded that natamycin and imidacloprid have a synergistic combined effect against the fungus Colletotrichum at ratio's between 1:1 to 100:1.

TABLE 16
Antifungal effect of natamycin in combination with imidacloprid against
Colletotrichum infection tested on the skin of pepper fruits.

| Natamycin-insecticide | Avg infected | Observed | Expected | | |
|---|---|---|---|---|---|
| (ppm) | area (mm2) | % | % | O/E | Interaction |
| 0:0 | 42.2 | 0.0 | | | |
| 1:0 | 30.2 | 28.6 | | | |
| 0:1 | 27.9 | 34.1 | | | |
| 0:0.04 | 23.3 | 44.7 | | | |
| 0:0.01 | 18.5 | 56.3 | | | |
| 1:1 | 18.5 | 56.1 | 52.9 | 1.1 | Synergism |
| 1:0.04 | 10.5 | 75.1 | 60.6 | 1.2 | Synergism |
| 1:0.01 | 7.5 | 82.1 | 68.8 | 1.2 | Synergism |

### Example 15. Antifungal Effect of Natamycin in Combination with Chlorantraniliprole Against Colletotrichum Species Infection Tested on the Skin of Pepper Fruits

### Material and Methods

The experiments were performed as described in Example 11. The fungus was isolated from Colletotrichum-infected plant material and identified using techniques known to the person skilled in the art. Assessment of the efficacy was 5 days after inoculation. Experiment was performed in 5-fold.

TABLE 17
Antifungal effect of natamycin in combination with chlorantraniliprole against
Colletotrichum sp. infection tested on the skin of pepper fruits.

| Natamycin-insecticide | Avg infected | Observed | Expected | | |
|---|---|---|---|---|---|
| (ppm) | area (mm2) | % | % | O/E | Interaction |
| 0:0 | 55.3 | 0.0 | | | |
| 1:0 | 22.4 | 59.5 | | | |
| 0:1 | 66.4 | −20.2 | | | |
| 0:0.04 | 55.6 | −0.7 | | | |
| 0:0.01 | 38.8 | 29.8 | | | |
| 1:1 | 15.3 | 72.3 | 51.3 | 1.4 | Synergistic |
| 1:0.04 | 17.7 | 67.9 | 59.2 | 1.1 | Synergistic |
| 1:0.01 | 18.5 | 66.5 | 71.5 | 0.9 | Not synergistic |

### Results

Results are presented in Table 17. It was concluded that natamycin and chlorantraniliprole have a synergistic combined effect against the fungus Colletotrichum at ratio's 1:1 to 25:1.

### Example 16. Antifungal Effect of Natamycin in Combination with Imidacloprid Against Botrytis cinerea on Tested on Banana Fruits

### Material and Methods

The experiments were performed as described in Example 11. Imidacloprid was formulated as described in Table 2. Assessment of the efficacy was 5 days after inoculation. Experiment was performed in 4-fold.

### Results

Results are presented in Tables 18A and 18B. It was concluded that natamycin and imidacloprid have a synergistic combined effect against the fungus Botrytis cinerea at ratio's 1:1 to 100:1.

TABLE 18A
Antifungal effect of natamycin in combination with imidacloprid against
Botrytis cinerea infection tested on the peel of banana fruits.

| Natamycin-insecticide | Avg infected | Observed | Expected | | |
|---|---|---|---|---|---|
| (ppm) | area (mm2) | % | % | O/E | Interaction |
| 0:0 | 49.1 | 0.0 | | | |
| 1:0 | 30.7 | 37.6 | | | |
| 0:1 | 32.4 | 34.1 | | | |
| 0:0.04 | 53.2 | −8.3 | | | |
| 0:0.01 | 35.6 | 27.6 | | | |
| 1:1 | 19.3 | 60.6 | 58.8 | 1.0 | Synergism |
| 1:0.04 | 21.9 | 55.5 | 32.4 | 1.7 | Synergism |
| 1:0.01 | 20.6 | 59 | 54.8 | 1.1 | Synergism |

Since the ratio natamycin:imidacloprid 100:1 was still synergistic, the ratio of 250:1 was also tested.

TABLE 18B
Antifungal effect of natamycin in combination with imidacloprid against
Botrytis cinerea infection tested on the peel of banana fruits.

| Natamycin-insecticide | Avg infected | Observed | Expected | | |
|---|---|---|---|---|---|
| (ppm) | area (mm2) | % | % | O/E | Interaction |
| 0:0 | 29.3 | 0.0 | | | |
| 1:0 | 25.9 | 11.6 | | | |
| 0:0.004 | 16.6 | 43.3 | | | |
| 1:0.004 | 34.1 | −16.5 | 49.8 | −0.3 | No synergism |

### Example 17. Antifungal Effect of Natamycin in Combination with Fipronil Against Colletotrichum Infection Tested on the Skin of Pepper Fruits

### Material and Methods

In this experiment, the product Fipronil WG-Ex 80% of company Schirm (Schirm GmbH, Schönebeck, Germany) containing the active ingredient fipronil belonging to IRAC Group 2 was tested.

The experiments were performed as described in Example 11. The fungus was isolated from Colletotrichum-infected plant material and identified using techniques known to the person skilled in the art. Assessment of the infection area was performed 6 days after inoculation. Experiment was performed in 5-fold.

### Results

Results are presented in Table 19. It was concluded that natamycin and fipronil have a synergistic combined effect against the fungus Colletotrichum in the tested ratios.

TABLE 19
Antifungal effect of natamycin in combination with fipronil against
Colletotrichum infection tested on the skin of pepper fruits.

| Natamycin:fipronil | Avg infected | Observed | Expected | | |
|---|---|---|---|---|---|
| (ppm) | area (mm²) | % | % | O/E | Interaction |
| 0:0 | 50.1 | 0.0 | | | |
| 1:0 | 24.7 | 50.7 | | | |
| 0:1 | 80.4 | −60.5 | | | |
| 0:0.04 | 76.8 | −53.4 | | | |
| 0:0.01 | 88.2 | −76.1 | | | |
| 1:1 | 13.9 | 72.3 | 20.8 | 3.5 | Synergism |
| 1:0.04 | 15.0 | 70.1 | 24.3 | 2.9 | Synergism |
| 1:0.01 | 28.9 | 42.3 | 13.1 | 3.2 | Synergism |

### Example 18: Antifungal Effect of Natamycin in Combination with Abamectin Against Colletotrichum Infection Tested on the Skin of Pepper Fruits

### Material and Methods

The experiments were performed as described in Example 11. The fungus was isolated from Colletotrichum-infected plant material and identified using techniques known to the person skilled in the art. Assessment of the infection area was performed 4 days after inoculation. Experiment was performed in 5-fold. In this experiment, the product VERTIMEC® of company Syngenta (Syngenta Group, Basel, Switzerland) containing the active ingredient abamectin belonging to IRAC Group 6 was tested.

### Results

Results are presented in Table 20. It was concluded that natamycin and abamectin have a synergistic combined effect against the fungus Colletotrichum in the tested ratios

TABLE 20
Antifungal effect of natamycin in combination with abamectin against
Colletotrichum infection tested on the skin of pepper fruits.

| Natamycin:abamectin | Avg infected | Observed | Expected | | |
|---|---|---|---|---|---|
| (ppm) | area (mm2) | % | % | O/E | Interaction |
| 0:0 | 22.4 | 0.0 | | | |
| 1:0 | 13.5 | 39.8 | | | |
| 0:0.04 | 30.7 | −37.0 | | | |
| 0:0.01 | 29.0 | −29.3 | | | |
| 1:0.04 | 9.5 | 57.5 | 17.6 | 3.3 | Synergism |
| 1:0.01 | 14.1 | 37.1 | 22.2 | 1.7 | Synergism |

1. An antifungal composition comprising natamycin and at least one insecticide of subgroup 2, 3, 4, 6 and/or 28 as identified in the document “IRAC Mode of Action Classification Scheme”, wherein said antifungal composition is suitable for the control of pests that are encountered in horticulture, agriculture, and forestry, and wherein the ratio of natamycin to the at least one insecticide is between 200:1 and 1:1 (w/w).

2. The antifungal composition according to claim 1, comprising 2% to 99% (w/w) of natamycin and 1% to 99% (w/w) of said at least one insecticide.

3. The antifungal composition according to claim 1, wherein the ratio of natamycin to the at least one insecticide is between 100:1 and 1:1 (w/w).

4. The antifungal composition according to claim 1, comprising natamycin and at least one insecticide selected from fipronil, lambda-cyhalothrin, alpha cypermethrin, emamectin benzoate, acetamiprid, clothianidin, imidacloprid, thiacloprid, thiamethoxam, abamectin and chlorantraniliprole.

5. The antifungal composition according to claim 1, further comprising an agriculturally acceptable carrier.

6. The antifungal composition according to claim 1, which is an aqueous or oily composition.

7. The composition according to claim 1, wherein the natamycin is milled to an average particle size of between 0.5 and 10 micrometers.

8. The composition according to claim 1, further comprising an insoluble polyelectrolyte complex of a polyanion and a polycation in relative amounts of between 1:2 and 60:1 (w/w).

9. A method for protecting an agricultural plant or plant part, comprising providing natamycin and at least one insecticide that interferes with the nervous system and/or muscular system of insects and nematodes and applying said natamycin and at least one insecticide that interferes with the nervous system and/or muscular system of insects and nematodes to said agricultural plant or plant part.

10. The method according to claim 9, wherein said plant part is a fruit or vegetable.

11. A method for improving the development and/or yield of an agricultural plant, comprising providing natamycin and at least one insecticide that interferes with the nervous system and/or muscular system of insects and nematodes and contacting the plant with said natamycin and at least one insecticide that interferes with the nervous system and/or muscular system of insects and nematodes.

12. A method for protecting a soil and/or a growth substrate, the method comprising applying to said soil and/or a growth substrate natamycin and at least one insecticide that interferes with the nervous system and/or muscular system of insects and nematodes.

13. The method according to claim 12, wherein the growth substrate is a mushroom growth substrate.

14. The method according to claim 9, whereby said composition is undiluted or diluted in an aqueous solution or in oil, prior to providing the composition to a plant or plant part.

15. (canceled)

16. The method according to claim 2, wherein the composition comprises 6% to 60% (w/w) of natamycin.

17. The method according to claim 2, wherein the composition comprises 5-50% (w/w) of said at least one insecticide.

18. The method according to claim 8, wherein said insoluble polyelectrolyte complex of a polyanion is a lignin compound.

19. The method according to claim 8, wherein said polycation is chitosan or poly-allylamine.

20. The method according to claim 12, whereby said composition is undiluted or diluted in an aqueous solution or in oil, prior to applying the composition to said soil and/or growth substrate.
